(19) United States
(12) Patent Application Publication
(10) Pub. No.: US 2017/0364742 A1
(43) Pub. Date: Dec. 21, 2017

(54) LIP-READING RECOGNITION METHOD AND APPARATUS BASED ON PROJECTION EXTREME LEARNING MACHINE

(71) Applicant: Huawei Technologies Co., Ltd., Shenzhen (CN)

(72) Inventors: Xinman Zhang, Xi'an (CN); Zhiqi Chen, Xi'an (CN); Kunlong Zuo, Beijing (CN)

(73) Assignee: HUAWEI TECHNOLOGIES CO., LTD., Shenzhen (CN)

(21) Appl. No.: 15/694,201

(22) Filed: Sep. 1, 2017

Related U.S. Application Data
(63) Continuation of application No. PCT/CN2016/074769, filed on Feb. 27, 2016.

(30) Foreign Application Priority Data
Mar. 2, 2015 (CN) 201510092861.1

(51) Int. Cl. G06K 9/00; G06K 9/62; G06T 7/11; G06K 9/46

(52) U.S. Cl. CPC G06K 9/00335; G06K 9/4647; G06K 9/6256; G06T 7/11; G06K 9/00281; G06T 2207/10016

(57) ABSTRACT

Disclosed are a lip-reading recognition method and apparatus based on a projection extreme learning machine. The method includes: obtaining a training sample and a test sample that are corresponding to the projection extreme learning machine PELM, where the training sample and the test sample each include n videos, n is a positive integer greater than 1, the training sample includes a category identifier corresponding to each video in the training sample; training the PELM according to the training sample, and determining a weight matrix W of an input layer in the PELM and a weight matrix β of an output layer in the PELM, to obtain a trained PELM; and identifying a category identifier of the test sample according to the test sample and the trained PELM. The lip-reading recognition method and apparatus based on the projection extreme learning machine can improve lip-reading recognition accuracy.

### CROSS-REFERENCE TO RELATED APPLICATIONS

This application is a continuation of International Application No. PCT/CN2016/074769, filed on Feb. 27, 2016, which claims priority to Chinese Patent Application No. 201510092861.1, filed on Mar. 2, 2015. The disclosures of the aforementioned applications are hereby incorporated by reference in their entireties.

### TECHNICAL FIELD

Embodiments of the present invention relate to communications technologies, and in particular, to a lip-reading recognition method and apparatus based on a projection extreme learning machine.

### BACKGROUND

A lip-reading recognition technology is a very important application in human-computer interaction (HCl), and plays an important role in an automatic speech recognition (ASR) system.

In the prior art, to implement a lip-reading recognition function, a feature extraction module and a recognition module usually need to cooperate. For the feature extraction module, the following two solutions are usually used: (1) In a model-based method, several parameters are used to represent a lip outline that is closely related to voice, and a linear combination of some parameters is used as an input feature. (2) In a pixel-based low-level semantic feature extraction method, an image plane is considered as a two-dimensional signal from a perspective of signal processing, an image signal is converted by using a signal processing method, and a converted signal is output as a feature of an image. For the recognition module, the following solutions are usually used: (1) In a neural network-based error back propagation (BP) algorithm and a support vector machine (SVM) classification method, a feature vector of a to-be-recognized lip image is input to a BP network for which training is completed, an output of each neuron at an output layer is observed, and a training sample corresponding to an output neuron that outputs a maximum value and that is of the neurons at the output layer is matched with the feature vector. (2) In a hidden Markov model (HMM) method based on a double-random process, a lip-reading process can be considered as a double-random process. A correspondence between each lip movement observed value and a lip-reading articulation sequence is random. That is, an observer can see only an observed value but cannot see lip-reading articulation, and existence and a characteristic of the lip-reading articulation can be determined only by using a random process. Then, the lip-reading process is considered as a selection process in which lip-reading signals in each very short period of time are linear and can be represented by using a linear model parameter, and then the lip-reading signals are described by using a first-order Markov process.

However, in the prior art, a feature extraction solution has a relatively strict environment requirement, and is excessively dependent on an illumination condition in a lip region during model extraction. Consequently, included lip movement information is incomplete, and recognition accuracy is low. In addition, in a lip-reading recognition technical solution, a recognition result is dependent on a hypothesis of a model on reality. If the hypothesis is improper, the recognition accuracy may be relatively low.

### SUMMARY

Embodiments of the present invention provide a lip-reading recognition method and apparatus based on a projection extreme learning machine, so as to improve recognition accuracy.

According to a first aspect, an embodiment of the present invention provides a lip-reading recognition method based on a projection extreme learning machine, including:

obtaining a training sample and a test sample that are corresponding to the projection extreme learning machine PELM, where the training sample and the test sample each include n videos, n is a positive integer greater than 1, the training sample further includes a category identifier corresponding to each video in the training sample, and the category identifier is used to identify a lip movement in each of the n videos;

training the PELM according to the training sample, and determining a weight matrix W of an input layer in the PELM and a weight matrix β of an output layer in the PELM, to obtain a trained PELM; and

identifying a category identifier of the test sample according to the test sample and the trained PELM.

With reference to the first aspect, in a first possible implementation of the first aspect, the obtaining a training sample and a test sample that are corresponding to the projection extreme learning machine PELM specifically includes:

collecting at least one video frame corresponding to each of the n videos, and obtaining a local binary pattern LBP feature vector ν_{L} and a histogram of oriented gradient HOG feature vector ν_{H} of each video frame;

aligning and fusing the LBP feature vector ν_{L} and the HOG feature vector ν_{H} according to a formula ν=∂ν_{L}+(1−∂)ν_{H} to obtain a fusion feature vector ν, where ∂ is a fusion coefficient, and a value of ∂ a is greater than or equal to 0 and less than or equal to 1;

performing dimension reduction processing on the fusion feature vector ν, to obtain a dimension-reduced feature vector x; and

obtaining a covariance matrix of each video by means of calculation according to the dimension-reduced feature vector x, to obtain a video feature vector y, and using a set Y={y₁, y₂ . . . yᵢ . . . yₙ} of the video feature vectors y of all of the n videos as the training sample and the test sample that are corresponding to the PELM, where n is a quantity of the videos, and yᵢ is a video feature vector of the i^{th} video.

With reference to the first possible implementation of the first aspect, in a second possible implementation of the first aspect, the obtaining a local binary pattern LBP feature vector ν_{L} of each video frame specifically includes:

dividing the video frame into at least two cells, and determining an LBP value of each pixel in each cell;

calculating a histogram of each cell according to the LBP value of each pixel in the cell, and performing normalization processing on the histogram of each cell, to obtain a feature vector of the cell; and

connecting the feature vectors of the cells, to obtain the LBP feature vector ν_{L} of each video frame, where a value of each component of the LBP feature vector ν_{L} is greater than or equal to 0 and less than or equal to 1.

With reference to the first possible implementation of the first aspect, in a third possible implementation of the first aspect, the obtaining a histogram of oriented gradient HOG feature vector ν_{H} of each video frame specifically includes:

converting an image of the video frame to a grayscale image, and processing the grayscale image by using a Gamma correction method, to obtain a processed image;

calculating a gradient orientation of a pixel at coordinates (x,y) in the processed image according to a formula

$$α ( x , y ) = {tan}^{- 1} ( \frac{{G}_{y} ( x , y )}{{G}_{x} ( x , y )} ) ,$$

where α(x,y) is the gradient orientation of the pixel at the coordinates (x,y) in the processed image, Gₓ(x,y) is a horizontal gradient value of the pixel at the coordinates (x,y) in the processed image, G_{y}(x,y) is a vertical gradient value of the pixel at the coordinates (x,y) in the processed image, Gₓ(x,y)=H(x+1,y)−H(x−1,y), G_{y}(x,y)=H(x,y+1)−H(x,y−1), and H(x,y) is a pixel value of the pixel at the coordinates (x,y) in the processed image; and

obtaining the HOG feature vector ν_{H} of each video frame according to the gradient orientation, where a value of each component of the HOG feature vector ν_{H} is greater than or equal to 0 and less than or equal to 1.

With reference to any one of the first aspect, or the first to the third possible implementations of the first aspect, in a fourth possible implementation of the first aspect, the training the PELM according to the training sample, and determining a weight matrix W of an input layer in the PELM and a weight matrix β of an output layer in the PELM specifically includes:

extracting a video feature vector of each video in the training sample, to obtain a video feature matrix P_{n*m} of all the videos in the training sample, where n represents a quantity of the videos in the training sample, and m represents a dimension of the video feature vectors;

performing singular value decomposition on the video feature matrix P_{n*m} according to a formula [U,S,V^{T}]=svd(P), to obtain Vₖ, and determining the weight matrix W of the input layer in the PELM according to a formula W=Vₖ, where S is a singular value matrix in which singular values are arranged in descending order along a left diagonal line, and U and V are respectively left and right singular matrices corresponding to S;

obtaining an output matrix H by means of calculation according to P_{n*m} S, U, and V by using a formula H=g(PV)=g(US) where g(•) is an excitation function; and

obtaining a category identifier matrix T, and obtaining the weight matrix β of the output layer in the PELM by means of calculation according to the category identifier matrix T and a formula β=H⁺T, where H⁺ is a pseudo-inverse matrix of H, and the category identifier matrix T is a set of category identifier vectors in the training sample.

According to a second aspect, an embodiment of the present invention provides a lip-reading recognition apparatus based on a projection extreme learning machine, including:

an obtaining module, configured to obtain a training sample and a test sample that are corresponding to the projection extreme learning machine PELM, where the training sample and the test sample each include n videos, n is a positive integer greater than 1, the training sample further includes a category identifier corresponding to each video in the training sample, and the category identifier is used to identify a lip movement in each of the n videos;

a processing module, configured to train the PELM according to the training sample, and determine a weight matrix W of an input layer in the PELM and a weight matrix β of an output layer in the PELM, to obtain a trained PELM: and

a recognition module, configured to identify a category identifier of the test sample according to the test sample and the trained PELM.

With reference to the second aspect, in a first possible implementation of the second aspect, the obtaining module includes:

an obtaining unit, configured to collect at least one video frame corresponding to each of the n videos, and obtain a local binary pattern LBP feature vector ν_{L} and a histogram of oriented gradient HOG feature vector ν_{H} of each video frame, where

the obtaining unit is further configured to align and fuse the LBP feature vector ν_{L} and the HOG feature vector ν_{H} according to a formula ν=∂ν_{L}+(1−∂)ν_{H}, to obtain a fusion feature vector ν, where ∂ is a fusion coefficient, and a value of ∂ is greater than or equal to 0 and less than or equal to 1;

a processing unit, configured to perform dimension reduction processing on the fusion feature vector ν, to obtain a dimension-reduced feature vector x; and

a calculation unit, configured to obtain a covariance matrix of each video by means of calculation according to the dimension-reduced feature vector x, to obtain a video feature vector y, and use a set Y={y₁, y₂ . . . yᵢ . . . yₙ} of the video feature vectors y of all of the n videos as the training sample and the test sample that are corresponding to the PELM, where n is a quantity of the videos, and yᵢ is a video feature vector of the i^{th} video.

With reference to the first possible implementation of the second aspect, in a second possible implementation of the second aspect, the obtaining unit is specifically configured to:

divide the video frame into at least two cells, and determine an LBP value of each pixel in each cell;

calculate a histogram of each cell according to the LBP value of each pixel in the cell, and perform normalization processing on the histogram of each cell, to obtain a feature vector of the cell; and

connect the feature vectors of the cells, to obtain the LBP feature vector ν_{L} of each video frame, where a value of each component of the LBP feature vector ν_{L} is greater than or equal to 0 and less than or equal to 1.

With reference to the first possible implementation of the second aspect, in a third possible implementation of the second aspect, the obtaining unit is specifically configured to:

convert an image of the video frame to a grayscale image, and process the grayscale image by using a Gamma correction method, to obtain a processed image;

calculate a gradient orientation of a pixel at coordinates (x,y) in the processed image according to a formula

$$α ( x , y ) = {tan}^{- 1} ( \frac{{G}_{y} ( x , y )}{{G}_{x} ( x , y )} ) ,$$

where α(x,y) is the gradient orientation of the pixel at the coordinates (x,y) in the processed image, Gₓ(x,y) is a horizontal gradient value of the pixel at the coordinates (x,y) in the processed image, G_{y}(x,y) is a vertical gradient value of the pixel at the coordinates (x,y) in the processed image, Gₓ(x,y)=H(x+1,y)−H(x−1,y), G_{y}(x,y)=H(x,y+1)−H(x,y−1), and H(x,y) is a pixel value of the pixel at the coordinates (x,y) in the processed image; and

obtain the HOG feature vector ν_{H} of each video frame according to the gradient orientation, where a value of each component of the HOG feature vector ν_{H} is greater than or equal to 0 and less than or equal to 1.

With reference to any one of the second aspect, or the first to the third possible implementations of the second aspect, in a fourth possible implementation of the second aspect, the processing module includes:

an extraction unit, configured to extract a video feature vector of each video in the training sample, to obtain a video feature matrix P_{n*m} of all the videos in the training sample, where n represents a quantity of the videos in the training sample, and m represents a dimension of the video feature vectors;

a determining unit, configured to perform singular value decomposition on the video feature matrix P_{n*m} according to a formula [U,S,V^{T}]=svd(P), to obtain Vₖ, and determine the weight matrix W of the input layer in the PELM according to a formula W=Vₖ, where S is a singular value matrix in which singular values are arranged in descending order along a left diagonal line, and U and V are respectively left and right singular matrices corresponding to S; and

a calculation unit, configured to obtain an output matrix H by means of calculation according to P_{n*m}, S, and V by using a formula H=g(PV)=g(US) where g(•) is an excitation function, and

the calculation unit is further configured to obtain a category identifier matrix T, and obtain the weight matrix β of the output layer in the PELM by means of calculation according to the category identifier matrix T and a formula β=H⁺T, where H⁺ is a pseudo-inverse matrix of H, and the category identifier matrix T is a set of category identifier vectors in the training sample.

According to the lip-reading recognition method and apparatus based on a projection extreme learning machine provided in the present invention, a training sample and a test sample that are corresponding to the PELM are obtained, where the training sample and the test sample each include n videos, n is a positive integer greater than 1, the training sample includes a category identifier corresponding to each video in the training sample, and the category identifier is used to identify a lip movement in each of the n videos: the PELM is trained according to the training sample, and a weight matrix W of an input layer in the PELM and a weight matrix β of an output layer in the PELM are determined, to obtain a trained PELM; and a category identifier of the test sample is obtained according to the test sample and the trained PELM. The PELM is trained by using the training sample, and the weight matrix W of the input layer and the weight matrix β of the output layer are determined, to obtain the trained PELM, so as to identify the category identifier of the test sample. Therefore, lip-reading recognition accuracy is improved.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a lip-reading recognition method based on a projection extreme learning machine according to the present invention;

FIG. 2 is a schematic flowchart of Embodiment 2 of a lip-reading recognition method based on a projection extreme learning machine according to the present invention;

FIG. 3 is a schematic diagram of LBP feature extraction;

FIG. 4 is a schematic flowchart of Embodiment 3 of a lip-reading recognition method based on a projection extreme learning machine according to the present invention;

FIG. 5 is a schematic structural diagram of Embodiment 1 of a lip-reading recognition apparatus based on a projection extreme learning machine according to the present invention;

FIG. 6 is a schematic structural diagram of Embodiment 2 of a lip-reading recognition apparatus based on a projection extreme learning machine according to the present invention; and

FIG. 7 is a schematic structural diagram of Embodiment 3 of a lip-reading recognition apparatus based on a projection extreme learning machine according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

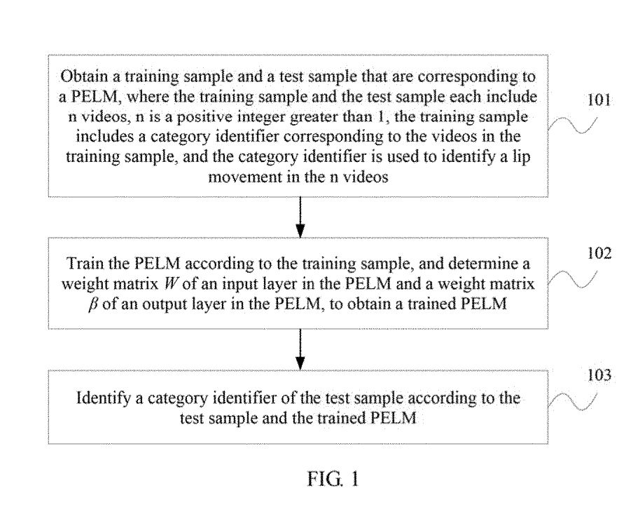

FIG. 1 is a flowchart of Embodiment 1 of a lip-reading recognition method based on a projection extreme learning machine according to the present invention. As shown in FIG. 1, the method in this embodiment may include the following steps.

Step 101: Obtain a training sample and a test sample that are corresponding to the PELM, where the training sample and the test sample each include n videos, n is a positive integer greater than 1, the training sample includes a category identifier corresponding to each video in the training sample, and the category identifier is used to identify a lip movement in each of the n videos.

Persons skilled in the art may understand that, an appropriate quantity of hidden layer nodes are set in the projection extreme learning machine (PELM), to randomly assign values to an input layer weight and a hidden layer offset; and then an output layer weight may be directly obtained by means of calculation by using a least square method. The whole process is completed at one time without iteration. A speed is improved by over ten times than that of a BP neural network. In this embodiment, each of the obtained training sample and test sample that are corresponding to the PELM include multiple videos, and the training sample further includes a category identifier of the videos. The category identifier is used to identify different lip movements in multiple videos, for example, 1 may be used to identify “sorry”, and 2 may be used to identify “thank you”.

Step 102: Train the PELM according to the training sample, and determine a weight matrix W of an input layer in the PELM and a weight matrix β of an output layer in the PELM, to obtain a trained PELM.

In this embodiment, the PELM includes an input layer, a hidden layer, and an output layer. The input layer, hidden layer, and output layer are connected in sequence. After the training sample corresponding to the PELM is obtained, the PELM is trained according to the training sample, to determine the weight matrix W of the input layer and the weight matrix β of the output layer.

Step 103: Identify a category identifier of the test sample according to the test sample and the trained PELM.

In this embodiment, after training of the PELM is completed, the trained PELM is obtained. After the test sample is input to the trained PELM, the category identifier of the test sample can be obtained according to an output result, to complete lip-reading recognition.

For example, a total of 20 experimental commands are used during recognition. In each command, five samples are used as training samples, and five samples are used as test samples. Then, there are a total of 100 samples for training and 100 samples for testing. Table 1 shows comparison of experiment results of a PELM algorithm and an HMM algorithm.

TABLE 1

| | | | | | HMM | PELM |
|---|---|---|---|---|---|---|
| | HMM | PELM | HMM | PELM | recog- | recog- |
| | training | training | testing | testing | nition | nition |
| Volunteer | time (s) | time (s) | time (s) | time (s) | rate | rate |
| 1 | 8.7517 | 2.6208 | 0.0468 | 0.0936 | 93% | 99% |
| 2 | 3.7284 | 2.1684 | 0.0468 | 0.0936 | 87% | 94% |
| 3 | 5.3352 | 2.2028 | 0.0468 | 0.1248 | 96% | 100% |
| 4 | 1.9968 | 2.1372 | 0.0936 | 0.0936 | 87% | 99% |
| 5 | 2.4180 | 2.1372 | 0.0312 | 0.0624 | 81% | 97% |
| 6 | 7.1136 | 2.0742 | 0.0468 | 0.1248 | 84% | 98% |
| 7 | 8.5021 | 2.3556 | 0.0780 | 0.1248 | 83% | 100% |
| 8 | 3.8220 | 2.1684 | 0.0312 | 0.0936 | 86% | 96% |
| 9 | 1.7472 | 2.1372 | 0.0312 | 0.1248 | 81% | 91% |
| 10 | 1.9656 | 2.0748 | 0.0312 | 0.1248 | 67% | 86% |

It can be learned that an average recognition rate based on the PELM algorithm reaches 96%, but an average recognition rate based on the conventional HMM algorithm is only 84.5%. In addition, in terms of a training time, an average training time of the PELM is 2.208 (s), but an average training time of the HMM algorithm is as long as 4.538 (s).

According to the lip-reading recognition method based on a projection extreme learning machine provided in this embodiment of the present invention, a training sample and a test sample that are corresponding to the PELM are obtained, where the training sample and the test sample each include n videos, n is a positive integer greater than 1, the training sample includes a category identifier corresponding to each video in the training sample, and the category identifier is used to identify a lip movement in each of the n videos; the PELM is trained according to the training sample, and a weight matrix W of an input layer in the PELM and a weight matrix β of an output layer in the PELM are determined, to obtain a trained PELM; and a category identifier of the test sample is obtained according to the test sample and the trained PELM. The PELM is trained by using the training sample, and the weight matrix W of the input layer and the weight matrix β of the output layer are determined, to obtain the trained PELM, so as to identify the category identifier of the test sample. Therefore, a lip-reading recognition rate is improved.

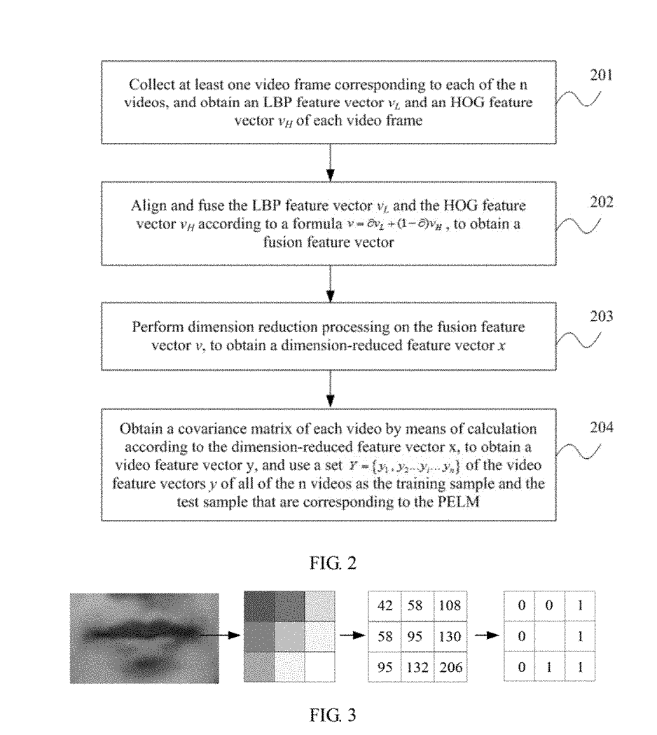

FIG. 2 is a schematic flowchart of Embodiment 2 of a lip-reading recognition method based on a projection extreme learning machine according to the present invention. This embodiment describes in detail, according to Embodiment 1 of the lip-reading recognition method based on a projection extreme learning machine, an embodiment of obtaining a training sample and a test sample that are corresponding to the PELM. As shown in FIG. 2, the method in this embodiment may include the following steps.

Step 201: Collect at least one video frame corresponding to each of the n videos, and obtain an LBP feature vector ν_{L} and an HOG feature vector ν_{H} of each video frame.

A local binary pattern (LBP) is an important feature for categorization in a machine vision field. The LBP focuses on description of local texture of an image, and can be used to maintain rotation invariance and grayscale invariance of the image. However, a histogram of oriented gradient (HOG) descriptor is a feature descriptor used to perform object detection in computer vision and image processing. The HOG focuses on description of a local gradient of an image, and can be used to maintain geometric deformation invariance and illumination invariance of the image. Therefore, an essential structure of an image can be described more vividly by using an LBP feature and an HOG feature. The following describes in detail a process of obtaining the LBP feature vector ν_{L} and an HOG feature vector ν_{H} of the video frame:

(1) Obtain the LBP Feature Vector ν_{L} of Each Video Frame.

A video includes multiple frames, and an overall feature sequence of the video can be obtained by processing each frame of the video. Therefore, processing the whole video can be converted into processing of each video frame.

First, the video frame is divided into at least two cells, and an LBP value of each pixel in each cell is determined.

FIG. 3 is a schematic diagram of LBP feature extraction. Specifically, after a video frame is collected, the video frame may be divided. A cell obtained after the division includes multiple pixels. For example, the video frame may be divided according to a standard that each cell includes 16×16 pixels after the division. The present invention imposes no specific limitation on a video frame division manner and a quantity of pixels included in each cell after division. For each pixel in a cell, the pixel is considered as a center, and a grayscale of the center pixel is compared with grayscales of eight adjacent pixels of the pixel. If a grayscale of an adjacent pixel is greater than the grayscale of the center pixel, a location of the adjacent pixel is marked as 1; If a grayscale of an adjacent pixel is not greater than the grayscale of the center pixel, a location of the adjacent pixel is marked as 0. In this way, an 8-bit binary number is generated after the comparison. Therefore, an LBP value of the center pixel is obtained.

Then, a histogram of each cell is calculated according to the LBP values of the pixels in the cell, and normalization processing is performed on the histogram of each cell, to obtain a feature vector of each cell.

Specifically, the histogram of each cell, that is, a frequency at which each LBP appears, may be calculated according to the LBP values of the pixels in the cell. After the histogram of each cell is obtained, normalization processing may be performed on the histogram of each cell. In a specific implementation process, processing may be performed by dividing a frequency at which each LBP value appears in each cell by a quantity of pixels included in the cell, to obtain the feature vector of each cell.

Finally, the feature vectors of the cells are connected, to obtain the LBP feature vector ν_{L} of each video frame.

Specifically, after the feature vectors of the cells are obtained, the feature vectors of the cells are connected in series, to obtain the LBP feature vector ν_{L} of each video frame. A value of each component of the LBP feature vector ν_{L} is greater than or equal to 0 and less than or equal to 1.

(2) Obtain the HOG Feature Vector ν_{H} of Each Video Frame.

A core idea of an HOG is that a detected local object shape can be described by using a light intensity gradient or distribution along an edge orientation. A whole image is divided into small cells. For each cell, a histogram of oriented gradient or an edge orientation of pixels in the cell is generated. A combination of the histograms can represent a target descriptor of the detected local object shape. A specific method for obtaining the HOG feature vector is as follows:

First, an image of the video frame is convened to a grayscale image, and the grayscale image is processed by using a Gamma correction method, to obtain a processed image.

In this step, each video frame includes an image. After the image of the video frame is converted to a grayscale image, the grayscale image is processed by using a Gamma correction method, and a contrast of the image is adjusted. This not only reduces impact caused by shade variance or illumination variance of a local part of the image, but also suppresses noise interference.

Then, a gradient orientation of a pixel at coordinates (x,y) in the processed image is calculated according to a formula

$$α ( x , y ) = {tan}^{- 1} ( \frac{{G}_{y} ( x , y )}{{G}_{x} ( x , y )} ) ,$$

where α(x,y) is the gradient orientation of the pixel at the coordinates (x,y) in the processed image, Gₓ(x,y) is a horizontal gradient value of the pixel at the coordinates (x,y) in the processed image, G_{y}(x,y) is a vertical gradient value of the pixel at the coordinates (x,y) in the processed image, Gₓ(x,y)=H(x+1,y)−H(x−1,y), G_{y}(x,y)=H(x,y+1)−H(x,y−1), and H(x,y) is a pixel value of the pixel at the coordinates (x,y) in the processed image.

Finally, the HOG feature vector ν_{H} of each video frame is obtained according to the gradient orientation.

Specifically, the video frame is divided into q cells. Each cell includes multiple pixels, for example, may include 4×4 pixels. Each cell is evenly divided into p orientation blocks along a gradient orientation, where p may be, for example, 9. Then, 0°-20° are one orientation block, 20°-40° are one orientation block, . . . , and 160°-180° are one orientation block. Then, an orientation block to which the gradient orientation of the pixel at the coordinates (x,y) belongs is determined, and a count value of the orientation block increases by 1. An orientation block to which each pixel in the cell belongs is calculated one by one by using the foregoing manner, so as to obtain a p-dimensional feature vector. q adjacent cells are used to form an image block, and normalization processing is performed on a q×p-dimensional feature vector in the image block, to obtain processed image block feature vectors. All image block feature vectors are connected in series, to obtain the HOG feature vector ν_{H} of the video frame. A quantity of cells may be set according to an actual situation, or may be selected according to a size of the video frame. The present invention imposes no specific limitation on a quantity of cells and a quantity of orientation blocks.

Step 202: Align and fuse the LBP feature vector ν_{L} and the HOG feature vector ν_{H} according to a formula ν=∂ν_{L}+(1−∂)ν_{H}, to obtain a fusion feature vector ν.

In this embodiment, ∂ is a fusion coefficient, and a value of ∂ is greater than or equal to 0 and less than or equal to 1. An LBP feature is a very powerful feature in terms of texture classification of an image, but an HOG feature reflects statistical information of a local region of an image. Line information can be highlighted by using a layer-based statistical policy, and the layer-based statistical policy is relatively sensitive to a structure such as a line. Therefore, after the LBP feature and the HOG feature are fused, a more stable effect can be obtained in terms of illumination variance and shade in an image. In addition, by means of obtaining the LBP feature and the HOG feature, redundancy of feature information extracted by using a pixel-based method can be reduced while more feature information is obtained, and language information included in a lip region can be described more accurately.

Step 203: Perform dimension reduction processing on the fusion feature vector ν, to obtain a dimension-reduced feature vector x.

In this embodiment, a dimension of the fusion feature vector ν obtained after fusion is dim^{ν}=dim^{ν}^{_{L}}+dim^{ν}^{_{H}}. Therefore, the fusion feature vector ν has a relatively large quantity of dimensions, and dimension reduction needs to be performed on the fusion feature vector ν. In a specific implementation process, dimension reduction may be performed by using a principal component analysis (PCA), to obtain the dimension-reduced feature vector x, where a dimension of the dimension-reduced feature vector x is dim^{x}, and dim^{x} is less than or equal to dim^{ν}. Therefore, a feature vector X of each video may be obtained according to formula (1):

$${X}_{{i}^{*} {dim}^{x}} = [ \begin{matrix}{x}_{1} \\ {x}_{2} \\ ⋮ \\ {x}_{i} \\ ⋮ \\ {x}_{t}\end{matrix} ] , \qquad ( 1 )$$

where

t is a quantity of frames in the video, and xᵢ is a dimension-reduced feature vector of the i^{th} frame of the video.

Step 204: Obtain a covariance matrix of each video by means of calculation according to the dimension-reduced feature vector x, to obtain a video feature vector y, and use a set Y={y₁, y₂ . . . yᵢ . . . yₙ} of the video feature vectors y of all of the n videos as the training sample and the test sample that are corresponding to the PELM.

In this embodiment, quantities of video frames included in different videos may be different. Therefore, a problem that dimensions of video feature vectors of the videos are different may be caused. To resolve this problem, the video feature vector of each video needs to be normalized. In actual application, normalization may be performed by calculating a covariance of the video feature vector. Specifically, the normalized video feature vector y of each video may be obtained by using formula (2) and formula (3):

$$mean = {[ \begin{matrix}{mean}_{col} ( {X}_{{i}^{*} {dim}^{x}} ) \\ ⋮ \\ {mean}_{col} ( {X}_{{i}^{*} {dim}^{x}} )\end{matrix} ]}_{{t}^{*} {dim}^{x}} , \qquad ( 2 )$$

and

y=(X_{t*dim}_{^{x}}−mean)^{T}*(X_{t*dim}_{^{x}}−mean) (3), where

mean_{col}(X_{t*dim}_{^{x}}) represents a row vector including an average value of each column of X_{t*dim}_{^{x}}.

After the normalized video feature vector y of each video is obtained, the set Y={y₁, y₂ . . . yᵢ . . . yₙ} of the video feature vectors y of all the videos is used as the training sample and the test sample that are corresponding to the PELM, where n is a quantity of the videos, and yᵢ is a video feature vector of the i^{th} video.

According to the lip-reading recognition method based on a projection extreme learning machine provided in this embodiment of the present invention, a training sample and a test sample that are corresponding to the PELM are obtained, where the training sample and the test sample each include n videos, n is a positive integer greater than 1, the training sample includes a category identifier corresponding to each video in the training sample, and the category identifier is used to identify a lip movement in each of the n videos; the PELM is trained according to the training sample, and a weight matrix W of an input layer in the PELM and a weight matrix β of an output layer in the PELM are determined, to obtain a trained PELM; and a category identifier of the test sample is obtained according to the test sample and the trained PELM. The PELM is trained by using the training sample, and the weight matrix W of the input layer and the weight matrix β of the output layer are determined, to obtain the trained PELM, so as to identify the category identifier of the test sample. Therefore, a lip-reading recognition rate is improved. In addition, an LBP feature vector and an HOG feature vector of an obtained video frame are fused, so that higher stability can be obtained for illumination variance and shade in an image, and lip-reading recognition accuracy is improved.

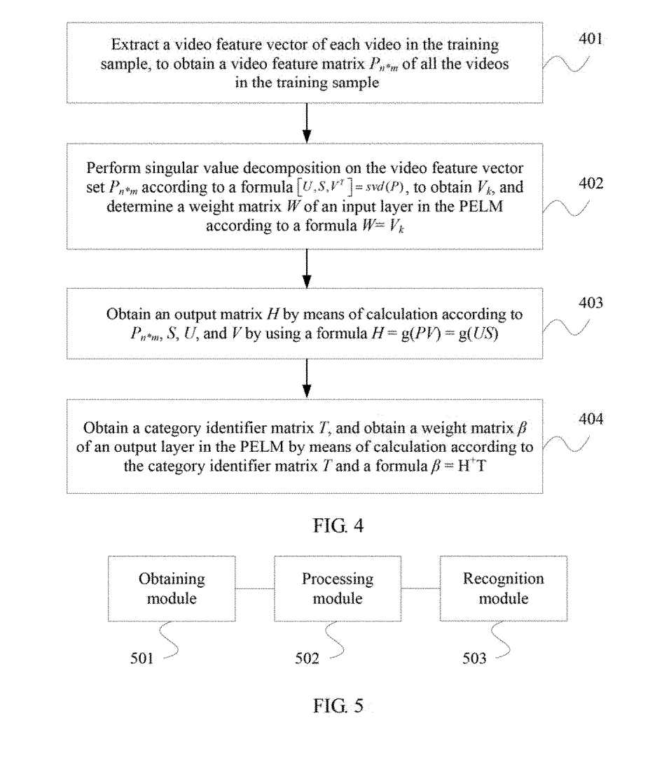

FIG. 4 is a schematic flowchart of Embodiment 3 of a lip-reading recognition method based on a projection extreme learning machine according to the present invention. This embodiment describes in detail, on a basis of the foregoing embodiments, an embodiment of training the PELM according to a training sample and a category identifier and determining a weight matrix W of an input layer in the PELM and a weight matrix β of an output layer in the PELM. As shown in FIG. 3, the method in this embodiment may include the following steps.

Step 401: Extract a video feature vector of each video in the training sample, to obtain a video feature matrix P_{n*m} of all the videos in the training sample.

In this embodiment, after the training sample is obtained, the video feature vector of each video in the training sample is extracted, to obtain the video feature matrix, that is, an input matrix P_{n*m}, of all the videos in the training sample, where n represents a quantity of videos in the training sample, and m represents a dimension of the video feature vectors.

Step 402: Perform singular value decomposition on the video feature matrix P_{n*m} according to a formula [U,S,V^{T}]=svd(P), to obtain Vₖ, and determine the weight matrix W of the input layer in the PELM according to a formula W=Vₖ.

In this embodiment, S is a singular value matrix in which singular values are arranged in descending order along a left diagonal line, and U and V are respectively left and right singular matrices corresponding to S. In an extreme learning machine (ELM), a weight matrix of an input layer is determined by randomly assigning a value. As a result, performance of the ELM becomes extremely unstable in processing a small quantity of multidimensional samples. Therefore, in this embodiment, the weight matrix W of the input layer is obtained with reference to a singular value decomposition manner. In an actual application process, after singular value decomposition is performed on the video feature matrix P_{n*m} by using the formula [U,S,V^{T}]=svd(P), the obtained right singular matrix V can be used as the weight matrix W of the input layer.

Step 403: Obtain an output matrix H by means of calculation according to P_{n*m}, S, U, and V by using a formula H=g(PV)=g(US).

In this embodiment, P_{n*m} is represented in a form of PV=US in a low-dimensional space spanned from V. Because W=Vₖ, the output matrix H can be directly obtained by means of calculation according to the formula H=g(PV)=g(US), where g(•) is an excitation function, and may be, for example, a function such as Sigmoid, Sine, or RBF.

Step 404: Obtain a category identifier matrix T, and obtain the weight matrix β of the output layer in the PELM by means of calculation according to the category identifier matrix T and a formula β=H⁺T.

In this embodiment, H⁺ is a pseudo-inverse matrix of H, and the category identifier matrix T is a set of category identifier vectors in the training sample. The training sample includes category identifiers corresponding to videos. Therefore, the category identifier matrix Tₙ=[t₁, t₂ . . . tᵢ . . . tₙ]^{T} may be obtained by using the category identifiers corresponding to the videos, where n is a quantity of the videos in the training sample, tᵢ is a category identifier of the i^{th} video, and c is a total quantity of category identifiers. After the output matrix H is obtained, the weight matrix β of the output layer in the PELM can be obtained by using the formula β=H⁺T. Till now, training of the PELM is completed, and a test sample can be input to the PELM, to identify a category identifier of the test sample.

According to the lip-reading recognition method based on a projection extreme learning machine provided in this embodiment of the present invention, a training sample and a test sample that are corresponding to the PELM are obtained, where the training sample and the test sample each include n videos, n is a positive integer greater than 1, the training sample includes a category identifier corresponding to each video in the training sample, and the category identifier is used to identify a lip movement in each of the n videos; the PELM is trained according to the training sample, and a weight matrix W of an input layer in the PELM and a weight matrix β of an output layer in the PELM are determined, to obtain a trained PELM; and a category identifier of the test sample is obtained according to the test sample and the trained PELM. The PELM is trained by using the training sample, and the weight matrix W of the input layer and the weight matrix β of the output layer are determined, to obtain the trained PELM, so as to identify the category identifier of the test sample. Therefore, a lip-reading recognition rate is improved. In addition, the weight matrix of the input layer in the PELM and the weight matrix of the output layer in the PELM are determined with reference to a singular value decomposition manner, so that performance of the PELM is more stable, and a stable recognition rate is obtained.

FIG. 5 is a schematic structural diagram of Embodiment 1 of a lip-reading recognition apparatus based on a projection extreme learning machine according to the present invention. As shown in FIG. 5, the lip-reading recognition apparatus based on a projection extreme learning machine provided in this embodiment of the present invention includes an obtaining module 501, a processing module 502, and a recognition module 503.

The obtaining module 501 is configured to obtain a training sample and a test sample that are corresponding to the projection extreme learning machine PELM, where the training sample and the test sample each include n videos, n is a positive integer greater than 1, the training sample further includes a category identifier corresponding to each video in the training sample, and the category identifier is used to identify a lip movement in each of the n videos. The processing module 502 is configured to train the PELM according to the training sample, and determine a weight matrix W of an input layer in the PELM and a weight matrix β of an output layer in the PELM, to obtain a trained PELM. The recognition module 503 is configured to identify a category identifier of the test sample according to the test sample and the trained PELM.

According to the lip-reading recognition apparatus based on a projection extreme learning machine provided in this embodiment of the present invention, a training sample and a test sample that are corresponding to the PELM are obtained, where the training sample and the test sample each include n videos, n is a positive integer greater than 1, the training sample includes a category identifier corresponding to each video in the training sample, and the category identifier is used to identify a lip movement in each of the n videos; the PELM is trained according to the training sample, and a weight matrix W of an input layer in the PELM and a weight matrix β of an output layer in the PELM are determined, to obtain a trained PELM; and a category identifier of the test sample is obtained according to the test sample and the trained PELM. The PELM is trained by using the training sample, and the weight matrix W of the input layer and the weight matrix β of the output layer are determined, to obtain the trained PELM, so as to identify the category identifier of the test sample. Therefore, a lip-reading recognition rate is improved.

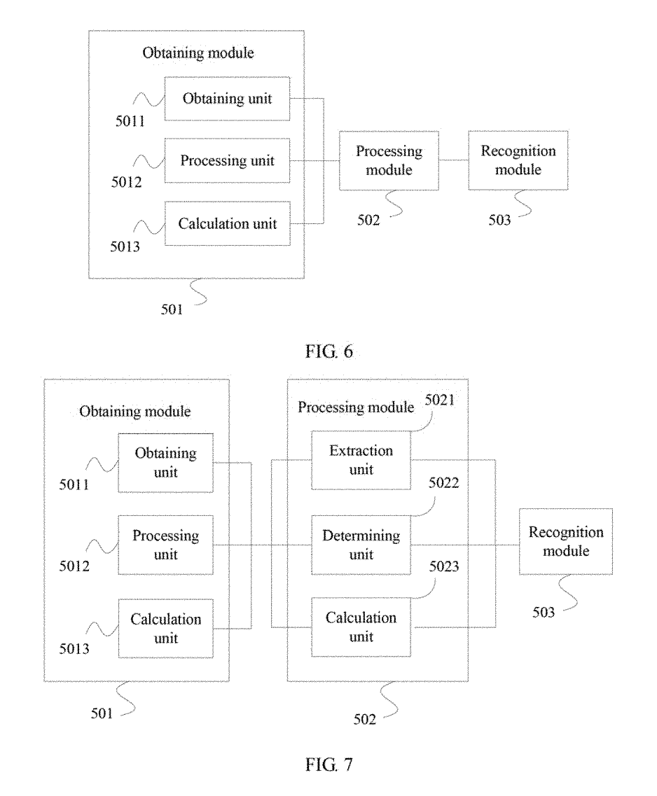

FIG. 6 is a schematic structural diagram of Embodiment 2 of a lip-reading recognition apparatus based on a projection extreme learning machine according to the present invention. As shown in FIG. 6, in this embodiment, on a basis of the embodiment shown in FIG. 5, the obtaining module 501 includes:

an obtaining unit 5011, configured to collect at least one video frame corresponding to each of the n videos, and obtain a local binary pattern LBP feature vector ν_{L} and a histogram of oriented gradient HOG feature vector ν_{H} of each video frame, where

the obtaining unit 5011 is further configured to align and fuse the LBP feature vector ν_{L} and the HOG feature vector ν_{H} according to a formula ν=∂ν_{L}+(1−∂)ν_{H}, to obtain a fusion feature vector ν, where ∂ is a fusion coefficient, and a value of ∂ is greater than or equal to 0 and less than or equal to 1:

a processing unit 5012, configured to perform dimension reduction processing on the fusion feature vector ν, to obtain a dimension-reduced feature vector x; and

a calculation unit 5013, configured to obtain a covariance matrix of each video by means of calculation according to the dimension-reduced feature vector x, to obtain a video feature vector y, and use a set Y={y₁ y₂ . . . yᵢ . . . yₙ} of the video feature vectors Y of all of the n videos as the training sample and the test sample that are corresponding to the PELM, where n is a quantity of the videos, and yᵢ is a video feature vector of the i^{th} video.

Optionally, the obtaining unit 5011 is specifically configured to:

divide the video frame into at least two cells, and determine an LBP value of each pixel in each cell;

calculate a histogram of each cell according to the LBP value of each pixel in the cell, and perform normalization processing on the histogram of each cell, to obtain a feature vector of the cell; and

connect the feature vectors of the cells, to obtain the LBP feature vector ν_{L} of each video frame, where a value of each component of the LBP feature vector ν_{L} is greater than or equal to 0 and less than or equal to 1.

Optionally, the obtaining unit 5011 is specifically configured to:

convert an image of the video frame to a grayscale image, and process the grayscale image by using a Gamma correction method, to obtain a processed image;

calculate a gradient orientation of a pixel at coordinates (x,y) in the processed image according to a formula

$$α ( x , y ) = {tan}^{- 1} ( \frac{{G}_{y} ( x , y )}{{G}_{x} ( x , y )} ) ,$$

where α(x,y) is the gradient orientation of the pixel at the coordinates (x,y) in the processed image, Gₓ(x,y) is a horizontal gradient value of the pixel at the coordinates (x,y) in the processed image. G_{y}(x,y) is a vertical gradient value of the pixel at the coordinates (x,y) in the processed image, Gₓ(x,y)=H(x+1,y)−H(x−1,y), G_{y}(x,y)=H(x, y+1)−H(x, y−1), and H(x,y) is a pixel value of the pixel at the coordinates (x,y) in the processed image; and

obtain the HOG feature vector ν_{H} of each video frame according to the gradient orientation, where a value of each component of the HOG feature vector ν_{H} is greater than or equal to 0 and less than or equal to 1.

The lip-reading recognition apparatus based on a projection extreme learning machine in this embodiment may be used to perform the technical solutions of the lip-reading recognition method based on a projection extreme learning machine provided in any embodiment of the present invention. An implementation principle and a technical effect of the lip-reading recognition apparatus are similar to those of the lip-reading recognition method, and details are not described herein again.

FIG. 7 is a schematic structural diagram of Embodiment 3 of a lip-reading recognition apparatus based on a projection extreme learning machine according to the present invention. As shown in FIG. 7, in this embodiment, on a basis of the foregoing embodiments, the processing module 502 includes:

an extraction unit 5021, configured to extract a video feature vector of each video in the training sample, to obtain a video feature matrix P_{n*m} of all the videos in the training sample, where n represents a quantity of the videos in the training sample, and m represents a dimension of the video feature vectors;

a determining unit 5022, configured to perform singular value decomposition on the video feature matrix P_{n*m} according to a formula [U,S,V^{T}]=svd(P), to obtain Vₖ, and determine the weight matrix W of the input layer in the PELM according to a formula W=Vₖ, where S is a singular value matrix in which singular values are arranged in descending order along a left diagonal line, and U and V are respectively left and right singular matrices corresponding to S; and

a calculation unit 5023, configured to obtain an output matrix H by means of calculation according to P_{n*m}, S, U, and V by using a formula H=g(PV)=g(US), where g(•) is an excitation function, and

the calculation unit 5023 is further configured to obtain a category identifier matrix T, and obtain the weight matrix β of the output layer in the PELM by means of calculation according to the category identifier matrix T and a formula β=H⁺T, where H⁺ is a pseudo-inverse matrix of H, and the category identifier matrix T is a set of category identifier vectors in the training sample.

The lip-reading recognition apparatus based on a projection extreme learning machine in this embodiment may be used to perform the technical solutions of the lip-reading recognition method based on a projection extreme learning machine provided in any embodiment of the present invention. An implementation principle and a technical effect of the lip-reading recognition apparatus are similar to those of the lip-reading recognition method, and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A lip-reading recognition method based on a projection extreme learning machine, comprising:
obtaining a training sample and a test sample that are corresponding to the projection extreme learning machine (PELM), wherein the training sample and the test sample each comprise n videos, n is a positive integer greater than 1, the training sample further comprises a category identifier corresponding to each video in the training sample, and the category identifier is used to identify a lip movement in each of the n videos;
training the PELM according to the training sample, and determining a weight matrix W of an input layer in the PELM and a weight matrix β of an output layer in the PELM, to obtain a trained PELM; and
identifying a category identifier of the test sample according to the test sample and the trained PELM.

2. The method according to claim 1, wherein the obtaining a training sample and a test sample that are corresponding to the PELM comprises:
collecting at least one video frame corresponding to each of the n videos, and obtaining a local binary pattern (LBP) feature vector ν_{L} and a histogram of oriented gradient (HOG) feature vector ν_{H} of each video frame;
aligning and fusing the LBP feature vector ν_{L} and the HOG feature vector ν_{H} according to a formula ν=∂ν_{L}+(1−∂)ν_{H}, to obtain a fusion feature vector ν, wherein ∂ is a fusion coefficient, and a value of ∂ is greater than or equal to 0 and less than or equal to 1;
performing dimension reduction processing on the fusion feature vector ν, to obtain a dimension-reduced feature vector x; and
obtaining a covariance matrix of each video by means of calculation according to the dimension-reduced feature vector x, to obtain a video feature vector y, and using a set Y={y₁, y₂ . . . yᵢ . . . yₙ} of the video feature vectors y of all of then videos as the training sample and the test sample that are corresponding to the PELM, wherein n is a quantity of the videos, and yᵢ is a video feature vector of the i^{th} video.

3. The method according to claim 2, wherein the obtaining the LBP feature vector ν_{L} of each video frame specifically comprises:
dividing the video frame into at least two cells, and determining an LBP value of each pixel in each cell;
calculating a histogram of each cell according to the LBP value of each pixel in the cell, and performing normalization processing on the histogram of each cell, to obtain a feature vector of the cell; and
connecting the feature vectors of the cells, to obtain the LBP feature vector ν_{L} of each video frame, wherein a value of each component of the LBP feature vector ν_{L} is greater than or equal to 0 and less than or equal to 1.

4. The method according to claim 2, wherein the obtaining the HOG feature vector ν_{H} of each video frame specifically comprises:
converting an image of the video frame to a grayscale image, and processing the grayscale image by using a Gamma correction method, to obtain a processed image;
calculating a gradient orientation of a pixel at coordinates (x,y) in the processed image according to a formula
$$α ( x , y ) = {tan}^{- 1} ( \frac{{G}_{y} ( x , y )}{{G}_{x} ( x , y )} ) ,$$
wherein α(x,y) is the gradient orientation of the pixel at the coordinates (x,y) in the processed image, Gₓ(x,y) is a horizontal gradient value of the pixel at the coordinates (x,y) in the processed image, G_{y}(x,y) is a vertical gradient value of the pixel at the coordinates (x,y) in the processed image, Gₓ(x,y)=H(x+1,y)−H(x−1,y) Gₓ(x,y)=H(x+1,y)−H(x−1,y), and H(x,y) is a pixel value of the pixel at the coordinates (x,y) in the processed image; and
obtaining the HOG feature vector ν_{H} of each video frame according to the gradient orientation, wherein a value of each component of the HOG feature vector ν_{H} is greater than or equal to 0 and less than or equal to 1.

5. The method according to claim 1, wherein the training the PELM according to the training sample, and determining a weight matrix W of an input layer in the PELM and a weight matrix β of an output layer in the PELM comprises:
extracting a video feature vector of each video in the training sample, to obtain a video feature matrix P_{n*m} of all the videos in the training sample, wherein n represents a quantity of the videos in the training sample, and m represents a dimension of the video feature vectors;
performing singular value decomposition on the video feature matrix P_{n*m} according to a formula [U,S,V^{T}]=(P), to obtain Vₖ, and determining the weight matrix W of the input layer in the PELM according to a formula W=Vₖ, wherein S is a singular value matrix in which singular values are arranged in descending order along a left diagonal line, and U and V are respectively left and right singular matrices corresponding to S;
obtaining an output matrix H by means of calculation according to P_{n*m}, S, U, and V by using a formula H=g(PV)=g(US), wherein (•) is an excitation function; and
obtaining a category identifier matrix T, and obtaining the weight matrix β of the output layer in the PELM by means of calculation according to the category identifier matrix T and a formula β=H⁺T, wherein H⁺ is a pseudo-inverse matrix of H, and the category identifier matrix T is a set of the category identifier in the training sample.

6. A lip-reading recognition apparatus based on a projection extreme learning machine, comprising:
a memory storage comprising instructions; and
one or more processors in communication with the memory, wherein the one or more processors execute the instructions to:
obtain a training sample and a test sample that are corresponding to the projection extreme learning machine (PELM), wherein the training sample and the test sample each comprise n videos, n is a positive integer greater than 1, the training sample further comprises a category identifier corresponding to each video in the training sample, and the category identifier is used to identify a lip movement in each of the n videos;
train the PELM according to the training sample, and determine a weight matrix W of an input layer in the PELM and a weight matrix β of an output layer in the PELM, to obtain a trained PELM; and
identify a category identifier of the test sample according to the test sample and the trained PELM.

7. The apparatus according to claim 6, wherein the one or more processors execute the instructions to:
collect at least one video frame corresponding to each of the n videos, and obtain a local binary pattern (LBP) feature vector ν_{L} and a histogram of oriented gradient (HOG) feature vector ν_{H} of each video frame, align and fuse the LBP feature vector ν_{L} and the HOG feature vector ν_{H} according to a formula ν=∂ν_{L}+(1−∂)ν_{H}, to obtain a fusion feature vector ν, wherein ∂ is a fusion coefficient, and a value of ∂ is greater than or equal to 0 and less than or equal to 1;
perform dimension reduction processing on the fusion feature vector ν, to obtain a dimension-reduced feature vector x; and
obtain a covariance matrix of each video by means of calculation according to the dimension-reduced feature vector x, to obtain a video feature vector y, and use a set Y={y₁, y₂ . . . yᵢ . . . yₙ} of the video feature vectors y of all of the n videos as the training sample and the test sample that are corresponding to the PELM, wherein n is a quantity of the videos, and yᵢ is a video feature vector of the i^{th} video.

8. The apparatus according to claim 7, wherein the one or more processors execute the instructions to:
divide the video frame into at least two cells, and determine an LBP value of each pixel in each cell;
calculate a histogram of each cell according to the LBP value of each pixel in the cell, and perform normalization processing on the histogram of each cell, to obtain a feature vector of the cell; and
connect the feature vectors of the cells, to obtain the LBP feature vector ν_{L} of each video frame, wherein a value of each component of the LBP feature vector ν_{L} is greater than or equal to 0 and less than or equal to 1.

9. The apparatus according to claim 7, wherein the one or more processors execute the instructions to:
convert an image of the video frame to a grayscale image, and process the grayscale image by using a Gamma correction method, to obtain a processed image;
calculate a gradient orientation of a pixel at coordinates (x,y) in the processed image according to a formula
$$α ( x , y ) = {tan}^{- 1} ( \frac{{G}_{y} ( x , y )}{{G}_{x} ( x , y )} ) ,$$
wherein α(x,y) is the gradient orientation of the pixel at the coordinates (x,y) in the processed image, Gₓ(x,y) is a horizontal gradient value of the pixel at the coordinates (x,y) in the processed image, G_{y}(x,y) is a vertical gradient value of the pixel at the coordinates (x,y) in the processed image, Gₓ(x,y)=H(x+1,y)−H(x−1,y), G_{y}(x,y)=H(x,y+1)−H(x,y−1), and (x,y) is a pixel value of the pixel at the coordinates (x,y) in the processed image; and
obtain the HOG feature vector ν_{H} of each video frame according to the gradient orientation, wherein a value of each component of the HOG feature vector ν_{H} is greater than or equal to 0 and less than or equal to 1.

10. The apparatus according to claim 6, wherein the one or more processors execute the instructions to:
extract a video feature vector of each video in the training sample, to obtain a video feature matrix P_{n*m} of all the videos in the training sample, wherein n represents a quantity of the videos in the training sample, and m represents a dimension of the video feature vectors;
perform singular value decomposition on the video feature matrix P_{n*m} according to a formula [U,S,V^{T}]=svd(P), to obtain Vₖ, and determine the weight matrix W of the input layer in the PELM according to a formula W=Vₖ, wherein S is a singular value matrix in which singular values are arranged in descending order along a left diagonal line, and U and V are respectively left and right singular matrices corresponding to S; and
obtain an output matrix H by means of calculation according to P_{n*m}, S, U, and V by using a formula H=g(PV)=g(US), wherein g(•) is an excitation function, and
obtain a category identifier matrix T, and obtain the weight matrix β of the output layer in the PELM by means of calculation according to the category identifier matrix T and a formula β=H⁺T, wherein H⁺ is a pseudo-inverse matrix of H, and the category identifier matrix T is a set of category identifier vectors in the training sample.

11. A non-transitory computer-readable medium having computer instructions stored thereon, that when executed by one or more processors, cause the one or more processors to perform the steps of:
obtaining a training sample and a test sample that are corresponding to the projection extreme learning machine (PELM), wherein the training sample and the test sample each comprise n videos, n is a positive integer greater than 1, the training sample further comprises a category identifier corresponding to each video in the training sample, and the category identifier is used to identify a lip movement in each of the n videos;
training the PELM according to the training sample, and determining a weight matrix W of an input layer in the PELM and a weight matrix β of an output layer in the PELM, to obtain a trained PELM; and
identifying a category identifier of the test sample according to the test sample and the trained PELM.
